(19) United States
(12) Patent Application Publication
(10) Pub. No.: US 2015/0052075 A1
(43) Pub. Date: Feb. 19, 2015

(54) LEARNING RELATIONSHIP MANAGEMENT SYSTEM

(71) Applicant: Fidelis Education, Inc., Mountain View, CA (US)

(72) Inventors: Anoop Jayadevan, Mountain View, CA (US); Erik Gunnar Counselman, Belmont, CA (US)

(73) Assignee: FIDELIS EDUCATION, INC., Mountain View, CA (US)

(21) Appl. No.: 14/530,125

(22) Filed: Oct. 31, 2014

Related U.S. Application Data
(60) Provisional application No. 60/066,099, filed on Nov. 17, 1997.

(51) Int. Cl. G06Q 50/20; G06Q 10/10

(52) U.S. Cl. CPC G06Q 50/2053; G06Q 10/10
USPC 705/327

(57) ABSTRACT

A learning relationship management system includes a personal learning plan unit in which a student of an educational institution sets his or her long-range educational and learning goals, and an advising unit that facilitates communications between students and their educational advisors. The learning relationship management system may include a teaching unit that facilitates creating online courses for students and providing them with the online courses. Automatic monitoring of student engagement in and achievement toward goals and activities can provide advisors with notifications of flags for students who fall behind, thereby allowing advisors or others to communicate with and support students at early sign of educational difficulty.

### RELATED APPLICATIONS

This application claims the benefit of the filing of provisional application No. 62/066,099, filed on Oct. 20, 2014.

### BACKGROUND

Customer Relationship Management (CRM) software has been used to help salespeople build and maintain customer relationships. CRM software is directed to providing salespeople a record of communications and transactions with customers so that salespeople can improve future communications and sales. Some universities and colleges have started to adapt CRM software for education purposes. However, CRM software is built to drive sales, and it treats customers like passive contacts to be acted upon by the salespeople. In a learning environment the learner is the primary agent in his or her own education, not a generally passive customer to be contacted and served by sale professionals. Accordingly, adaptations of CRM software still lack fundamental tools necessary for the distinctive context of a learning environment.

Accordingly, the present invention provides a learning relationship management system that includes a personal learning plan unit in which a student of an educational institution sets long-range educational and learning goals for students are outlined and an advising unit that facilitates communications between students and their educational advisors. The learning relationship management system may include a teaching unit that facilitates creating online courses for students and providing them with the online courses. Automatic monitoring of student engagement in and achievement toward goals and activities can provide advisors with notifications of flags for students who fall behind, thereby allowing advisors or others to communicate with and support students at early sign of educational difficulty.

Additional aspects and advantages of this invention will be apparent from the following detailed description of preferred embodiments, which proceeds with reference to the accompanying drawings.

### BRIEF DESCRIPTION OF THE DRAWINGS

FIG. 1 is a block diagram of a learning relationship management (LRM) system.

FIG. 2 is a block illustration of one implementation of a personal learning plan user interface.

FIG. 3 is a block diagram of a learning relationship manager user interface.

FIG. 4 is an illustration of a learning relationship management online course student user interface.

FIG. 5 is a block diagram of a learning relationship management online course builder user interface.

FIG. 6 illustrates a learning relationship management online course moderator dashboard user interface.

FIG. 7 illustrates a learning relationship management online course moderator student engagement user interface.

FIG. 8 is a flow diagram of a learning relationship management method.

FIG. 9 is a block diagram of a system having a computing device as an operating environment.

### DETAILED DESCRIPTION

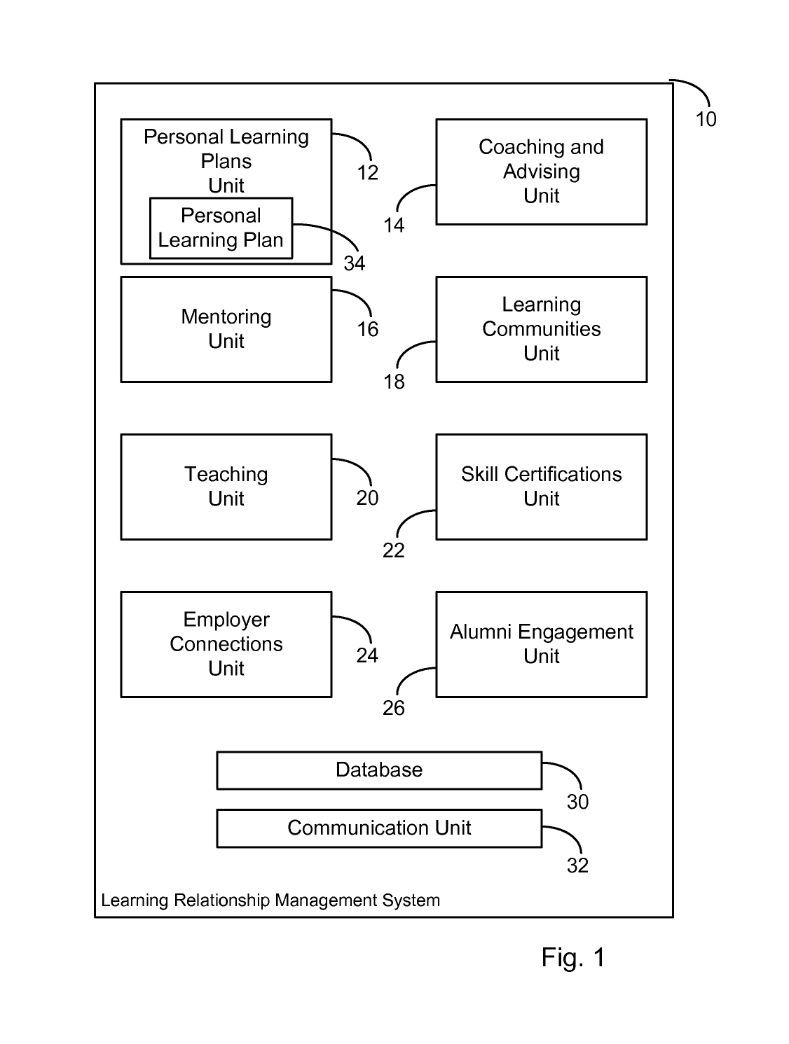

FIG. 1 is a block diagram of a learning relationship management (LRM) system 10 that provides in an educational setting services and functions that are particularly suited for the needs of students and educators to help students achieve educational success. LRM system 10 resides in and is executed on and accessed through one or more networked computers and provides for the students of an educational institution an environment and framework to support their education, educational goals, and entry into post-education work. In one implementation, learning relationship management system 10 includes any or all of multiple units, including a personal learning plans unit 12 in which long-range educational and learning goals for the students are outlined, and a coaching and advising unit 14 that facilitates communications between students and their advisors and coaches.

Also, a mentoring unit 16 may facilitate communications between students and peer and other volunteer mentors, and a learning communities unit 18 may provide social environments in which students find and interact with social and intellectual communities, advisors, mentors, and friends. A teaching unit 20 may facilitate online teaching by educators of the educational institution, and a skill certification or badge unit 22 may allow students to learn and document specific skills related to his or her learning plan. An employer connections unit 24 may facilitate communications between students and prospective employers, and an alumni engagement unit 26 may facilitate communications between students and alumni of the educational institution. LRM system 10 includes a database 30, which is accessible by units 12-26 and stores data and other information obtained and used by units 12-26, and a communication unit 32 that provides and facilitates communication between students, advisors, mentors, coaches and other users of LRM system 10, as described below in greater detail.

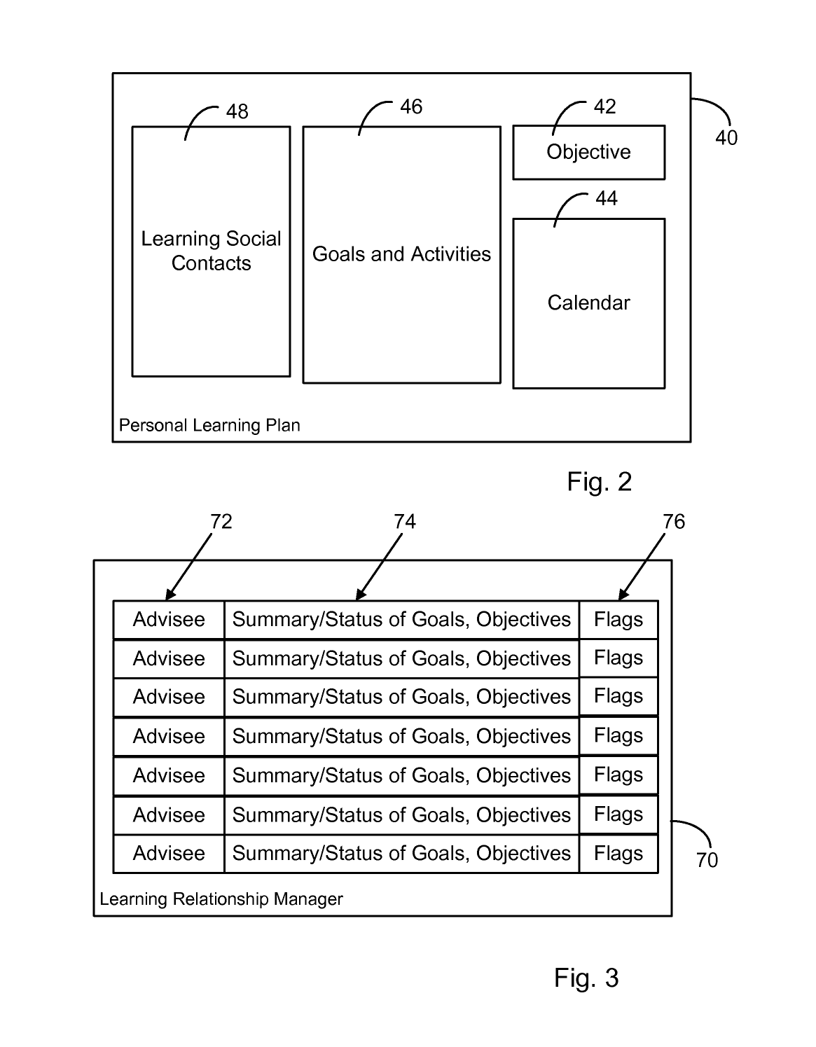

FIG. 2 is a block illustration of one implementation of a personal learning plan user interface 40 for a student operated as part of personal learning plans unit 12. Personal learning plan user interface 40 provides data and information that are stored in database 30 of LRM system 10 for display to a student on a computer-controlled display screen as part of a student's personal learning plan 34 (FIG. 1), which is contained within LRM system 10 and stored in association with a student's profile (not shown) that includes a record of identifying information about the student and a record of student achievements and activities and other information. In addition, personal learning plan user interface 40 allows the student to modify, edit, add to, or delete data and information in his or her personal learning plan 34 using, for example, conventional computer text editing user interface features and tools.

Personal learning plan user interface 40 is described as displaying exemplary information and data for a student as part of his or her personal learning plan 34 (FIG. 1), which information and data are stored in database 30 of LRM system 10 in association with the student. While the following description of personal learning plan user interface 40 refers to display elements for displaying information and data, it will be appreciated that the information and data referred to as being displayed in each display element are also stored in database 30 of LRM system 10.

An objective display unit 42 displays and allows editing of a student's educational objective, which is one or more achievements the student seeks to reach through completion of the educational program. A goals and activities display unit 44 displays particular programs, skill certifications, educational achievements, etc. that the student plans to complete toward achieving his or her objective. The goals and achievements may relate specifically to a student's educational area of focus or could also include general career advancement skills, such as writing or verbal communication, professional networking skills, or other general educational skills A calendar display unit 46 is included to assist the student in scheduling and tracking responsibilities, programs, etc., including those relating to goals and activities that are displayed in goals and activities display unit 44.

A learning social contacts display unit 48 lists includes contact information for and/or communication links to people who are or may be in communication with the student in relation to the student's personal learning plan 34 and would typically include at least a coach or advisor who is an educator of the educational institution and serves as a primary educational contact or counselor providing advice and guidance to the student. A communication link may include a link to an email address or a telephone number or direct messaging through communication unit 32 of LRM system 10, for example. In addition, learning social contacts section 48 may also include links to peer or other (e.g., professional) volunteer mentors who are available to assist or advise the student, peer mentees to whom the student is providing mentoring assistance, and learning social communities of people who share educational topics of interest with the student and who interact with the student through coaching and advising unit 14, mentoring unit 16, or learning communities unit 18.

In operation of learning relationship management system 10, each student designs, specifies, enters, or edits his or her own personal learning plan 34 through personal learning plan user interface 40, including specifying, entering, or editing an objective in objective display unit 42 and goals and activities in goals and activities display unit 46. A student can communicate with any advisor, coach or mentor through learning social contacts display unit 48 to seek any guidance, advice, information etc. relating to the student's education.

Learning relationship management system 10 includes a learning relationship manager user interface 70, illustrated as a block diagram in FIG. 3, that provides a mentor, advisor, or coach with learning management system information about a mentee, advisee, or coached student through the corresponding coaching and advising unit 14 or mentoring unit 16. Learning relationship manager user interface 70 is described as displaying exemplary information and data, which information and data are stored in database 30 of LRM system 10. While the following description of Learning relationship manager user interface 70 refers to display elements for displaying information and data, it will be appreciated that information and data referred to as being displayed in each display element are also stored in database 30 of LRM system 10.

Learning relationship manager user interface 70 provides for an advisor, coach or other educator an advisee display unit 72 and a status summary display unit 74, which together provide in summary form a listing of advisees for whom the advisor, coach other educator is responsible and the status of the advisees' goals and objectives. For example, each advisee listed in advisee display unit 72 may be indicated by his or her name and optionally a photograph, and the status summary display unit 74 may summarize goals that have been achieved, or are on schedule toward being achieved, behind schedule, or even the absence of goals.

By selecting an advisee in advisee display unit 72, the mentor, advisor, or coach is provided the personal learning plan 12 of that student to review the student's progress toward achieving his or her goals. The mentor, advisor, or coach may then contact the mentee, advisee, or coached student to communicate about any unmet or outstanding goals or about success in achieving completion of a goal. Optionally, learning relationship manager 70 may allow the advisor or coach to sort advisees 72 by name, by unmet goals or objectives, or completed achievements, and may include overall summations of the progress of all of an advisor's advisees toward their goals. In one implementation, the indication may be a simple numeral beside the mentee's, advisee's, or coached student's name or photograph indicating a number outstanding or unmet goals or activities. In addition, learning relationship manager 70 may include for any advisee a flag 76 that functions as a highlighted notification, provided by communication unit 32 of LRM system 10, for the advisor to note and take action on positive achievements, or undesired or incomplete events in the student's learning program. As another option, learning relationship manager 70 may provide the advisor with stand-alone notifications messages or alerts of student issues that warrant immediate attention.

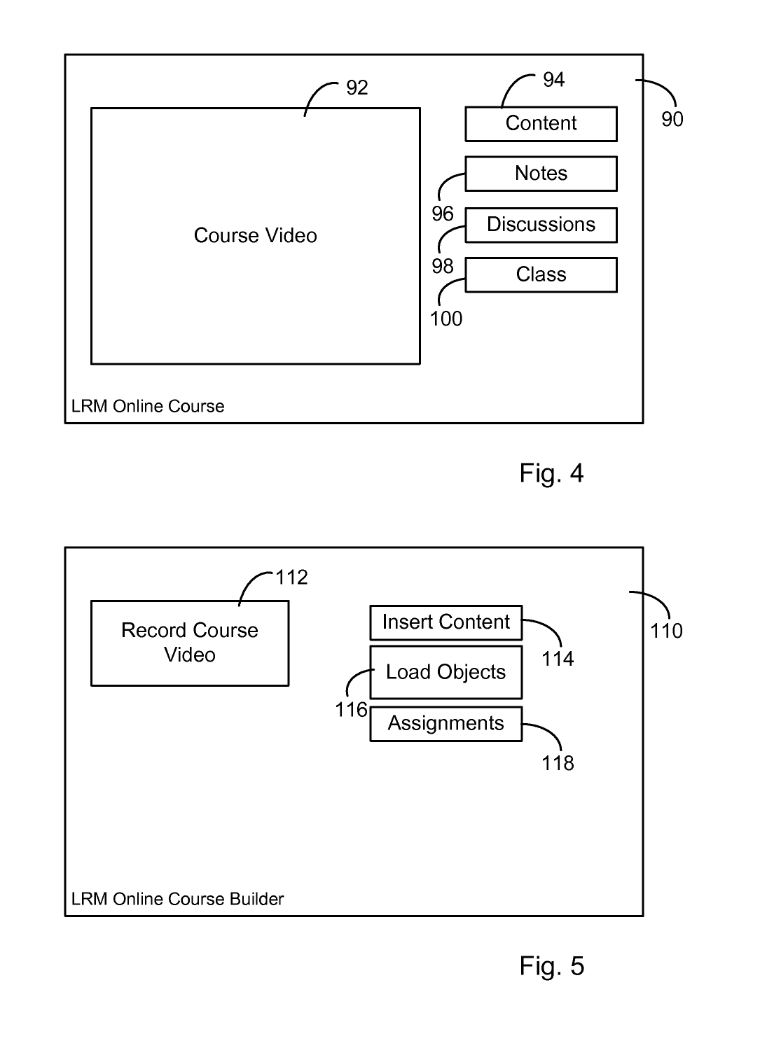

Goals and activities listed in goals and activities display unit 46 may include online courses, learning applications or “apps” that are made available to students through learning relationship management system 10. FIG. 4 is an illustration of an LRM online course student user interface 90 that as part of skill certification unit 22 is transmitted through learning relationship management system 10 to provide student instruction. LRM online course student user interface 90 may include a video pane 92 in which an educator presents a course segment in live or recorded video. The course segment may be a unitary program or may be one of a series of segments that together constitute a course.

In addition, LRM online course student user interface 90 includes a content link 94, activation of which lists an outline or table of contents of the subject matter in the course segment. Activation of a notes link 96 opens a notes display section (not shown) into which the student may enter notes while the course segment video plays. Activation of a discussions link 98 opens a discussion or chat board in which students may discuss the course segment among themselves or with the educator or course moderator. Activation of a class link 100 opens a list of the students who are currently taking the course (and, optionally, who recently have taken the course), along with links for contacting the students. LRM online course student user interface 90 provides a consistent display format and user interface that simplifies online learning for students through learning relationship system 10.

Teaching unit 20 of learning relationship management system 10 may also include an LRM online course builder user interface 110, illustrated as a block diagram in FIG. 5, that provides a simplified tool with which an educator can build LRM online course for display on LRM online course student user interface 90. LRM online course builder 110 includes a record course video control 112 that activates a video camera connected to an educator's computer to record a course segment, such as a course presentation or lecture made by the educator. An insert content control 114 allows the educator to incorporate an outline or table of contents of the subject matter in the course segment. A load objects control 116 allows the educator to load electronic copies of any documents or other materials to supplement the presentation in the course video, such as exercises, problem sets, quizzes or other tests, or other computer-active elements such as animations, interactive teaching tools with which students can interact, or other programmed functions or elements (sometimes called widgets) for presenting information, assessing student learning of the information, etc. An assignment control 118 allows the educator to insert or generate an assignment relating to the course segment. The assignment control 118 may open an assignment template (not shown) that can provide the educator with proposed information fields to complete, including assignment title, due date, and assignment details, for assignments that may be self-assessed, mentor-assessed, peer-assessed, or educator-assessed.

A LRM online course may be presented through LRM online course student user interface 90 with or without moderation. With moderation, an educator or an educator's assistant can provide students with assistance, feedback, or other information, either live during a LRM online course or at times other than a course presentation. Without moderation, a student may be self-guided or can work with other students on the course.

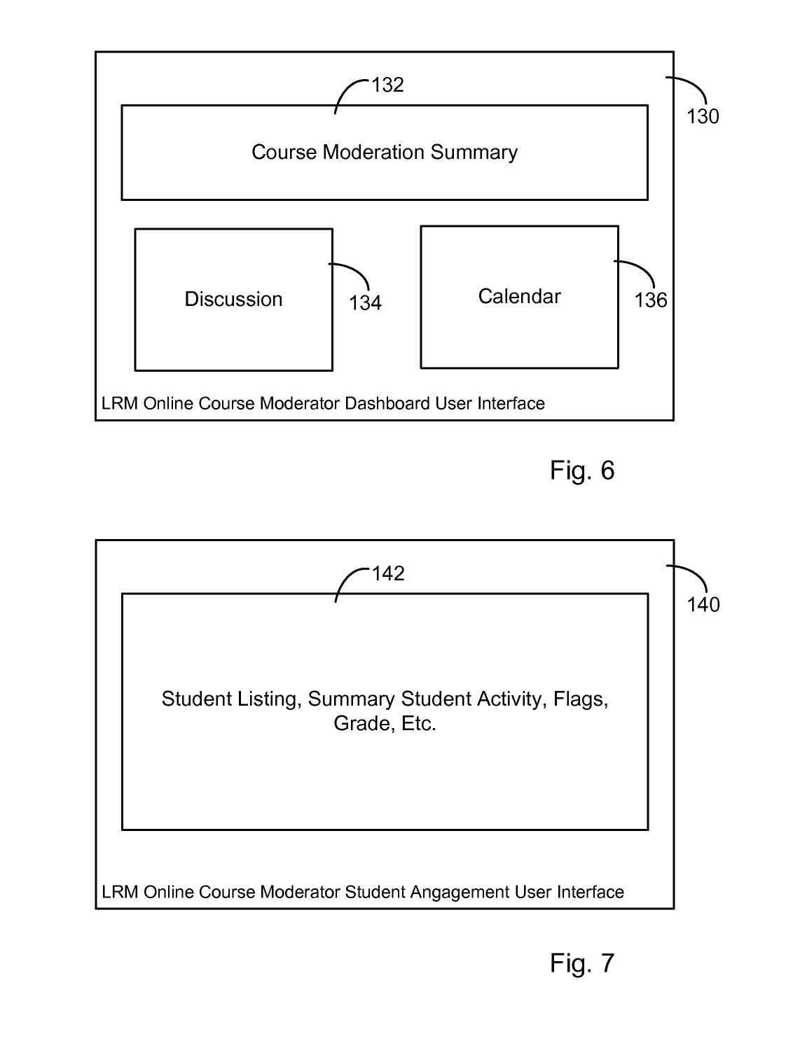

FIG. 6 illustrates a LRM online course moderator dashboard user interface 130 for use by a moderator of a LRM online course, either live during a LRM online course presentation or at other times. LRM online course moderator user interface 130 refers to display elements for displaying information and data, and it will be appreciated that information and data referred to as being displayed in each display element of user interface 130 or its related interfaces are also stored in database 30 of LRM system 10.

LRM online course moderator dashboard user interface 130 includes for each moderator a course moderation summary 132 that lists LRM courses that the moderator is moderating, including summary information about each course including the number of students, flags notifying the moderator of adequate or inadequate engagement of students in the course, an indication of the percentage of students who have accessed the course and completed assignments or tasks for the course. A discussion display unit 134 provides an interface to display communications to and from students, either directly between the moderator and individual students or as part of discussion threads or groups involving the moderator and multiple students. The moderator may choose through interface 130 whether discussion display unit 134 displays communications with students from all the moderator's LRM online courses together, or for individual LRM online courses at a time. A calendar display unit 136 displays a calendar with upcoming moderator dates of interest, such as quiz dates for courses, live interviews or presentations, grading deadlines, etc.

From dashboard user interface 130, a moderator may access an online course moderator student engagement user interface 140, which is illustrated in FIG. 7. Student engagement user interface 140 includes for each course a listing 142 of students taking the course, including links to profiles for the students (e.g., such as profiles available through learning relationship manager user interface 70), together with a summary of student activity in the course, which summary may include any or all of any flags of achievement or concern for the student in the course, the student's overall grade for the course, the number of discussion postings by the student, the percentage of completion of the course for the student, and the time (e.g., days) since the student last logged in to the course, actively interacted with it, or interacted with the moderator. The order of students in listing 142 may be selected by the moderator to be according to name, flags (of achievement or concern), or any of the other information fields included in user interface 140. A moderator may also access a course moderator task manager user interface (not shown) through which the moderator can manage for each course completion of tasks required of himself or herself and also monitor completion of tasks required of students including, for example, grading to be completed by the moderator and assignments, quizzes, exams or projects to be completed by students.

The scope and integration of learning relationship management (LRM) system 10, including access educators have to student personal profiles, community interactions such as with advisors and mentors, performance on and interactions with LRM online courses, and retrieving or receiving information from conventional student information systems (a common type of system used in education administration) and learning management systems (a common type of system used by educators to create and present educational materials), allows advisors and educators to monitor student performance across a wide range of educational contexts and to engage students early if or when performance or task completion issues arise. The information provided to advisors and educators by learning relationship management (LRM) system 10 extends well beyond conventional individual course-end grades to include ongoing indications of student performance and engagement with his or her education.

For example, learning relationship management (LRM) system 10 performs automatic tracking and analysis of student personal profiles, community interactions such as with advisors and mentors, performance on and interactions with LRM online courses, etc. As a result, learning relationship management (LRM) system 10 can automatically generate flags 76 described with reference to learning relationship manager 70 and flags described with reference to LRM online course moderator dashboard user interface 130 if a student's engagement or performance lag behind predefined goals or metrics.

In addition, learning relationship management (LRM) system 10 provides students with access to and communication with advisors, mentors and coaches who are all available to engage, support, advise and guide the student toward successful achievement of his or her educational objective. As a result, educators and advisors can communicate with and assist students much closer to the beginning of educational difficulties to provide assistance and guidance to help the student overcome the difficulties. In contrast, conventional educational monitoring, based mainly on end-of-term grading, may flag student difficulties far too late to provide timely assistance to the student.

Communication unit 32 of LRM system 10 (FIG. 1) not only facilitates communication between advisors and students, as described, but also facilitates communication between prospective mentors through mentor unit 16, prospective employers of students through employer connections unit 24, and communications between the educational institution and past students through alumni engagement unit 26. With regard to communications with prospective mentors, for example, mentor unit 16 may determine a likelihood of mutual benefit (LOMB) that indicates the extent of correlation or matching between profiles of students and prospective mentors. Based upon the likelihood of mutual benefit (LOMB) between a student and prospective mentors, an advisor can recommend suitable prospective mentors to a student, or suitable prospective student mentees to a mentor. For example, recommendations of mentors may emphasize certain differences from pre-existing mentors to provide a student mentee with a beneficial variety in mentors.

With regard to communications with prospective employers, students may make available their profiles to prospective employers through employer connection unit 24 demonstrating various relevant goals and activities the students have achieved in addition to completing their overall educational program, including “macro-credentials” (e.g., degrees, licenses, or other major certifications), “micro-credentials” (e.g., lesser certifications or badges documenting specific skills, such as those earned through certification or badge unit 22), and a timeline or history of work, volunteer, or educational experience. In addition, prospective employers can offer activities or goals through teaching unit 20, for example, to prepare students specifically with skills and abilities particularly suited to the employer.

In one implementation, employer connection unit 24 functions to correlate job requirements specified by an employer (e.g., including identifying keywords, macro- and micro-credentials, etc.) with matching student profiles to provide the employer with a filtered set of profiles from which to initiate communication with students. In addition, communication unit 32 can facilitate communications through alumni engagement unit 26 with past student alumni who can provide mentoring to following students or prospective employment contacts.

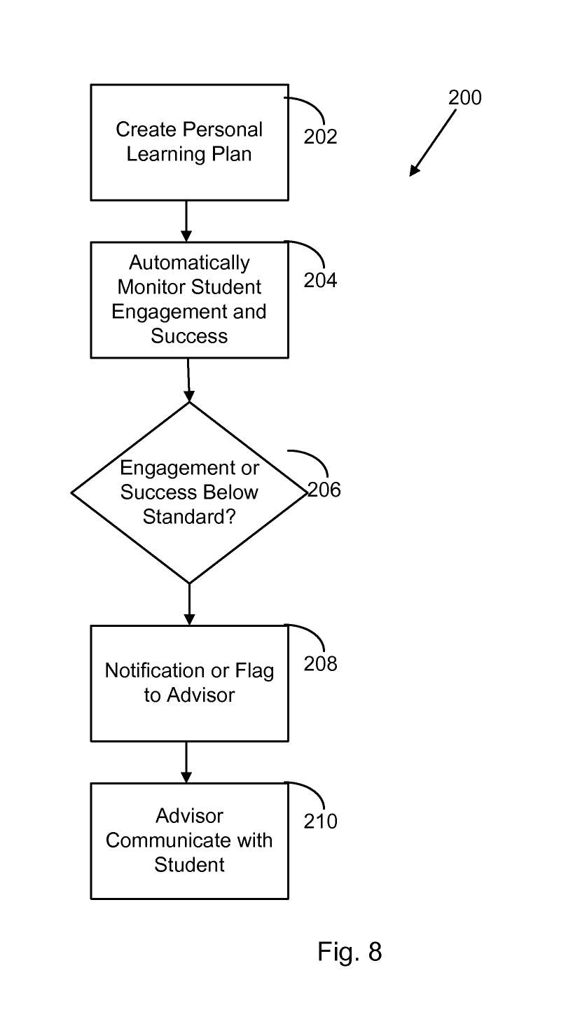

FIG. 8 is a flow diagram of a learning relationship management method 200 that may be performed by one or more computers in accordance with software or software instructions stored in tangible computer readable media.

In process step 202, a student creates a personal learning plan that includes an overall objective and goals and activities leading toward the objective.

In process step 204 student engagement with and success toward completing activities and achieving goals in the personal learning plan are monitored automatically.

In decision block 206, it is determined whether student engagement with and success toward completing activities and achieving goals falls below a predefined standard or metric. If student engagement with and success toward completing activities and achieving goals falls below a predefined standard or metric, decision block 206 proceeds to process block 208. If not, decision block returns to process block 204.

Process block 208 indicates that a notification or flag is provided to an advisor or educator of the student. The notification or flag may be a stand-alone notification delivered directly to the advisor or educator or may be included in a summary listing of information being reviewed or monitored by the advisor of educator.

Process block 210 indicates that the advisor or educator communicates with the student regarding the student's lack of engagement or success.

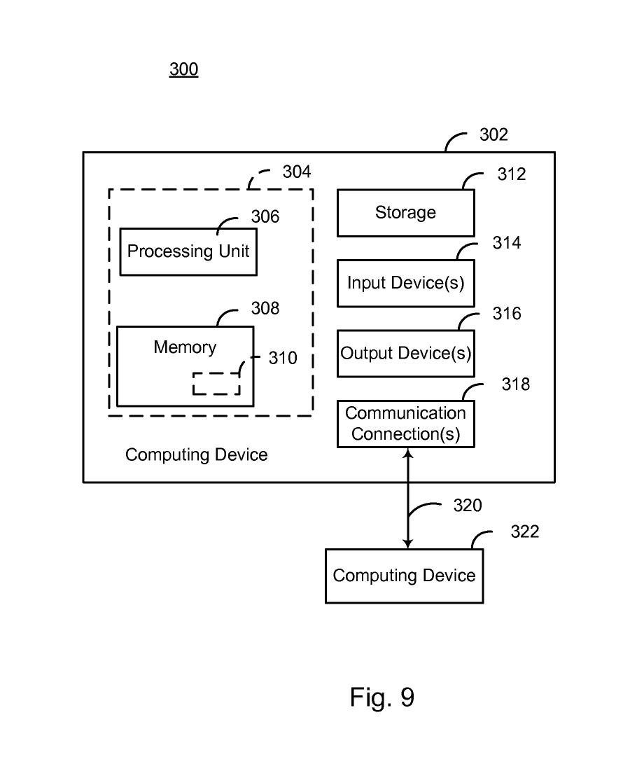

FIG. 9 is a block diagram of a system 300 having a computing device 302 as an operating environment of one or more embodiments described above. Computing device 302 includes a basic computing structure 304 having a processing unit 306 and a memory 308. Processing unit 306 executes or performs software or other computer-executed instructions 310 stored in memory 308 in accordance with operations described above. Processing unit 306 may include one or more of any of a central processing unit, a co-processor, and a dedicated or special-purpose processing unit (e.g., an audio processor). Memory 308 may include one or both of volatile memory (e.g., registers, cache, RAM) and non-volatile memory (e.g., ROM, EEPROM, flash memory), and may include one or more portions that are integrated with processing unit 306 or distinct from it. Memory 308 stores software or other computer-executed instructions 310 that are executed or executable by processing unit 306, and may also store other data or information. For example, instructions or code 310 may control the processor to carry out the operations illustrated in the flow diagram of FIG. 7.

Computing device 302 may also include any or all of the following additional components: storage 312, one or more input devices 314, one or more output devices 316, and one or more communication connections 318. An interconnection mechanism (not shown), such as a bus, controller, or network, interconnects the components of computing device 302. Typically, operating system software (not shown) provides an operating environment for software executed or performed by computing device 302 on and coordinates operation of its components.

Storage 312 may include portions that removable or non-removable and may include magnetic storage, optical storage, or electrical storage that may be local to or remote from basic computing structure 304. In one embodiment, software 310 and the operating system software may be stored in both memory 308 and storage 312, with software 310 and the operating system software being loaded in memory 308 from storage 312 for execution by processing unit 306.

In some embodiments, various software components, for example those shown in FIG. 15, may be stored in storage 312 and loaded into memory 308 from storage 312 for execution by the processing unit 304. With regard to FIG. 15, the illustrated allocation of various tasks or operations to specific software components is merely illustrative. Some or all of the various operations noted may be assigned to other components, or to one or more components not shown. The specific arrangements will depend on implementation. The software components may be programmed in any of a wide variety of programming languages and technologies, including, without limitation, the language C or C++ the latter being easier to parallelize for multi-processors. Further, various data, such as optimized asset allocation vectors (see FIG. 13), for example, may be stored in memory 308, or in storage 312, and such data may be exported, for example, by way of the user interface process 1530 or external data access process 1540.

To the extent used herein, including in the claims as filed or amended, the terms “computer readable medium” and “computer readable media” generally refer to any and all forms of memory 308 and storage 312 and may be volatile or nonvolatile, removable or non-removable, and by way of example and not limitation may include any or all of the following types: RAM, ROM, EEPROM, flash memory, or other memory circuit technologies, CD-ROM, Digital Versatile Disks (DVDs) or other optical storage, magnetic storage devices such as disks, tapes, cassettes, etc.

Input device or devices 314 may include one or more of: keyboard, keypad, touchscreen, touchpad, mouse, trackball, pen, voice input device, camera, scanner, or any other input device. Output device(s) 316 may include one or more of: display, speaker, printer, motion or action actuator or activator, transmitter, or any other output device. Each input device 314 and output device 316 may be connected to or communicate with computing device 302 via any wired or wireless connection employing any optical, electrical, electromagnetic, or acoustic communication.

Computing device 302 communicates through communication connection or connections 318 over a communication medium 320 with one or more other computing devices 322. Communication medium 320 carries information, such as data, computer-executable instructions, audio or video information, or other information, between computing devices 302 and 322. By way of example, communication medium 320 may include direct or networked communication between computing devices 302 and 322 and may include one or more of wired or wireless connections employing electrical, optical, electromagnetic, acoustic, or other carriers. As one example, communication medium 320 may include a global computer network such as the Internet.

It will be obvious to those having skill in the art that many changes may be made to the details of the above-described embodiments without departing from the underlying principles of the invention. The scope of the present invention should, therefore, be determined only by the following claims.

1. A learning relationship management system, comprising:
a personal learning plans unit in which students of an educational institution set long-range educational and learning goals for themselves in connection with personal learning plans;
an advising unit that facilitates communications between students and their educational advisors, including providing an educational advisor of a student with access to the personal learning plan of the student; and
a skill certification unit through which students learn and document specific skills related to his or her learning plan.

2. The learning relationship management system of claim 1 further comprising a mentoring unit that facilitates communications between students and mentors other than educational advisors.

3. The learning relationship management system of claim 2 in which the mentors include peer and non-peer mentors.

4. The learning relationship management system of claim 2 in which students and mentors have profiles and the mentoring unit identifies prospective student-mentor combinations according to correlations between student and mentor profiles.

5. The learning relationship management system of claim 1 further comprising an employer connections unit that facilitates communications between students and prospective employers.

6. The learning relationship management system of claim 1 further comprising a learning relationship manager user interface that provides an advisor with a summary of educational status of plural student advisees.

7. The learning relationship management system of claim 6 in which the learning relationship manager user interface automatically provides the advisor with notification flags indicating any educational engagement issues of student advisees.

8. The learning relationship management system of claim 1 further comprising a learning communities unit that provides an online social environment in which students interact with a social community that includes other students.

9. The learning relationship management system of claim 1 further comprising a database that stores in association with respective students their personal learning plans, communications between students and their educational advisors, and certification of documented skills.

10. A learning relationship management method performed by one or more computers in accordance with software or software instructions stored in tangible computer readable media, the method comprising:
storing for each of plural students a personal learning plan that includes an overall educational objective and goals and activities leading toward the objective;
automatic monitoring of student engagement with and success toward completing activities and achieving goals in his or her personal learning plan; and
providing automatic notification to an advisor for any student for whom engagement with and success toward completing activities and achieving goals falls below a predefined standard.

11. The method of claim 10 further comprising providing communication between the advisor for any student for whom engagement with and success toward completing activities and achieving goals falls below a predefined standard.
